(19) United States
(12) Patent Application Publication
(10) Pub. No.: US 2014/0170418 A1
(43) Pub. Date: Jun. 19, 2014

(54) ANTI-CORROSION COATING COMPOSITION AND USE THEREOF

(71) Applicant: AXALTA COATING SYSTEMS IP CO., LLC, Wilmingyon, DE (US)

(72) Inventors: Simona Percec, Philadelphia, PA (US); Susan H. Tilford, Ewing, NJ (US); Kayleigh J. Ferguson, Greenville, DE (US)

(73) Assignee: AXALTA COATING SYSTEMS IP CO., LLC, Wilmington, DE (US)

(21) Appl. No.: 14/119,929

(22) PCT Filed: May 23, 2012
(86) PCT No.: PCT/US2012/039078

§ 371 Date: Mar. 5, 2014

Related U.S. Application Data
(60) Provisional application No. 61/488,921, filed on May 23, 2011.

(51) Int. Cl. C23F 11/00; C25D 9/02; C09D 5/08

(52) U.S. Cl. CPC C23F 11/00; C09D 5/086; C25D 9/02
USPC 428/418; 524/607; 523/400; 252/500; 427/58; 205/317; 428/458; 428/460; 428/425.8

(57) ABSTRACT

Anti-corrosion coatings comprising electroconductive polymers polymerized in the presence of one or more film forming polymers are provided. These coatings can be used with metal substrates such as cold-rolled steel and other metals to inhibit corrosion.

### CROSS-REFERENCE TO RELATED APPLICATIONS

This application is a U.S. National-Stage entry under 35 U.S.C. §371 based on International Application No. PCT/US2012/039078, filed May 23, 2012 which was published under PCT Article 21(2) and which claims priority to U.S. Application No. 61/488,921, filed May 23, 2011, which are all hereby incorporated in their entirety by reference.

### TECHNICAL FIELD

The present invention is directed to an anti-corrosion coating composition. It is particularly directed to a coating composition comprising at least one electroconductive polymer. The coating composition can be used to produce an anti-corrosion coating over metal substrates.

### BACKGROUND

Current organic coatings for corrosion control are typically obtained from aqueous formulations of barrier resins and specific additives. The preferred technology for the application of organic coatings in the automotive industry is via electro-coating, since it can coat areas of formed or cast metal parts that are otherwise difficult to reach via other techniques, such as spray-coating. A typical cathodic electrocoating process is carried out by immersing a substrate that serves as a cathode in a cationic electrocoating composition and applying a voltage. The deposition of a coating layer on the substrate involves an electrochemical reaction, and the coating layer that has deposited on the substrate surface upon voltage application acts as an insulator, serving to limit the thickness of the coating.

Due to their electroactivity and electronic conductivity, electroconductive polymers (ECPs) are believed to participate in electronic interactions when they are in contact with active metals such as ferrous alloys. Such interactions are thought to alter metal corrosion behavior, and there is interest in using ECPs as anti-corrosion coatings on substrates such as cold-rolled steel (CRS). However, conducting polymers are insoluble in ordinary solvents and infusible because they decompose before melting, making it difficult to form ECP-derived coatings via standard solution- or melt-based processes.

Thus, there remains a need for a process to apply ECPs to metal substrates to provide anti-corrosion properties. In addition, other objects, desirable features and characteristics will become apparent from the subsequent summary and detailed description, and the appended claims, taken in conjunction with the accompanying drawings and this background.

### SUMMARY

This disclosure is directed to a coating composition comprising at least one electroconductive polymer polymerized in the presence of one or more film forming polymers selected from the group consisting of one or more polyester polymers, one or more acrylic polymers, epoxy polymers, melamine polymers, formaldehyde polymers, polyurethane polymers, and a combination thereof.

This disclosure is further directed to a process for producing an anti-corrosion coating layer over a metal substrate, said process comprising the steps of:

i) providing the coating composition of any one of coating compositions of this disclosure;

ii) applying said coating composition over said metal substrate to form a wet coating layer; and

iii) curing said wet coating layer to form said anti-corrosion coating layer.

### DETAILED DESCRIPTION

The following detailed description is merely exemplary in nature and is not intended to limit the exemplary embodiments or the application and uses thereof. Furthermore, there is no intention to be bound by any theory presented in the preceding background or the following detailed description.

The features and advantages of the present invention will be more readily understood, by those of ordinary skill in the art, from reading the following detailed description. It is to be appreciated that certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

The term “(meth)acrylate” means methacrylate or acrylate.

The term “two-pack coating composition”, also known as 2K coating composition, refers to a coating composition having two packages that are stored in separate containers and sealed to increase the shelf life of the coating composition during storage. The two packages are mixed just prior to use to form a pot mix, which has a limited pot life, typically ranging from a few minutes (15 minutes to 45 minutes) to a few hours (4 hours to 8 hours). The pot mix is then applied as a layer of a desired thickness on a substrate. After application, the layer dries and cures at ambient or at elevated temperatures to form a coating having desired coating properties, such as, adhesion, high gloss, mar-resistance and resistance to environmental etching.

The term “crosslinkable component” refers to a component having “crosslinkable functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with crosslinking functional groups (during a curing step) to produce a coating in the form of crosslinked structures. One of ordinary skill in the art would recognize that certain crosslinkable functional group combinations would be excluded, since, if present, these combinations would crosslink among themselves (self-crosslink), thereby destroying their ability to crosslink with the crosslinking functional groups. A workable combination of crosslinkable functional groups refers to the combinations of crosslinkable functional groups that can be used in coating applications excluding those combinations that would self-crosslink.

Typical crosslinkable functional groups can include hydroxyl, thiol, isocyanate, thioisocyanate, acid or polyacid, acetoacetoxy, carboxyl, primary amine, secondary amine, epoxy, anhydride, ketimine, aldimine, or a workable combination thereof. Some other functional groups such as orthoester, orthocarbonate, or cyclic amide that can generate hydroxyl or amine groups once the ring structure is opened can also be suitable as crosslinkable functional groups.

The term “crosslinking component” refers to a component having “crosslinking functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with the crosslinkable functional groups (during the curing step) to produce a coating in the form of crosslinked structures. One of ordinary skill in the art would recognize that certain crosslinking functional group combinations would be excluded, since, if present, these combinations would crosslink among themselves (self-crosslink), thereby destroying their ability to crosslink with the crosslinkable functional groups. A workable combination of crosslinking functional groups refers to the combinations of crosslinking functional groups that can be used in coating applications excluding those combinations that would self-crosslink. One of ordinary skill in the art would recognize that certain combinations of crosslinking functional group and crosslinkable functional groups would be excluded, since they would fail to crosslink and produce the film forming crosslinked structures. The crosslinking component can comprise one or more crosslinking agents that have the crosslinking functional groups.

Typical crosslinking functional groups can include hydroxyl, thiol, isocyanate, thioisocyanate, acid or polyacid, acetoacetoxy, carboxyl, primary amine, secondary amine, epoxy, anhydride, ketimine, aldimine, orthoester, orthocarbonate, cyclic amide or a workable combination thereof.

It would be clear to one of ordinary skill in the art that certain crosslinking functional groups crosslink with certain crosslinkable functional groups. Examples of paired combinations of crosslinkable and crosslinking functional groups can include: (1) ketimine functional groups crosslinking with acetoacetoxy, epoxy, or anhydride functional groups; (2) isocyanate, thioisocyanate and melamine functional groups each crosslinking with hydroxyl, thiol, primary and secondary amine, ketimine, or aldimine functional groups; (3) epoxy functional groups crosslinking with carboxyl, primary and secondary amine, ketimine, or anhydride functional groups; (4) amine functional groups crosslinking with acetoacetoxy functional groups; (5) polyacid functional groups crosslinking with epoxy or isocyanate functional groups; and (6) anhydride functional groups generally crosslinking with epoxy and ketimine functional groups.

The term “binder” or “film forming binder” as used herein refers to film forming constituents of a coating composition. Film forming polymers can be part of the binder. The binder in this disclosure can further comprise other polymers that are essential for forming the crosslinked films having desired properties. Other components, such as solvents, pigments, catalysts, rheology modifiers, antioxidants, UV stabilizers and absorbers, leveling agents, antifoaming agents, anti-cratering agents, or other conventional additives are typically not included in the term. One or more of those components can be included in the coating composition.

The term “dye” means a colorant or colorants that produce color or colors and is usually soluble in a coating composition.

The term “pigment” or “pigments” used herein refers to a colorant or colorants that produce color or colors and is usually not soluble in a coating composition. A pigment can be from natural and synthetic sources and made of organic or inorganic constituents. A pigment can also include metallic particles or flakes with specific or mixed shapes and dimensions. The term “effect pigment” or “effect pigments” refers to pigments that produce special effects in a coating. Examples of effect pigments can include, but are not limited to, light absorbing pigment, light scattering pigments, light interference pigments, and light reflecting pigments. Metallic flakes, for example aluminum flakes, can be examples of such effect pigments. The term “gonioapparent flakes”, “gonioapparent pigment” or “gonioapparent pigments” refers to pigment or pigments pertaining to change in color, appearance, or a combination thereof with change in illumination angle or viewing angle. Metallic flakes, such as aluminum flakes are examples of gonioapparent pigments. Interference pigments or pearlescent pigments can be further examples of gonioapparent pigments.

The term “vehicle”, “automobile” or “automobile vehicle” refers to an automobile; truck; semitruck; tractor; motorcycle; trailer; ATV (all terrain vehicle); pickup truck; heavy duty mover, such as, bulldozer, mobile crane and earth mover; airplanes; boats; ships; and other modes of transport.

A substrate suitable for this invention can be bare metal or treated metal such as blasted steel, phosphate treated steel, aluminum or other metals or alloys, or a combination thereof. In one example, a metal substrate can be steel. In another example, s metal substrate can be an alloy. In yet another example, a substrate can be an item having a plurality of metals.

This disclosure is directed to a coating composition. The coating composition can comprise at least one electroconductive polymer polymerized in the presence of one or more film forming polymers selected from the group consisting of polyester polymers, acrylic polymers, epoxy polymers, melamine polymers, formaldehyde polymers, polyurethane polymers, and a combination thereof.

The electroconductive polymer can be selected from polyaniline, polypyrrole, polythiophene, or a combination thereof.

The electroconductive polymer can be polypyrrole polymerized from pyrrole, substituted pyrrole, or a combination thereof, in the presence of said one or more film forming polymers. The electroconductive polymer can also be polyaniline polymerized from aniline, substituted aniline, or a combination thereof, in the presence of said one or more film forming polymers. The electroconductive polymer can further be polythiophene polymerized from thiophene, substituted thiophene, or a combination thereof, in the presence of said one or more film forming polymers.

The electroconductive polymer can further be a poly(aniline/pyrrole) polymerized from a reaction mixture comprising a first monomer mix comprising aniline, substituted aniline, or a combination thereof, a second monomer mix comprising pyrrole, substituted pyrrole, or a combination thereof, and said one or more film forming polymers. The electroconductive polymer can further be a polymer polymerized from a mixture comprising a combination of aniline, substituted aniline, pyrrole, substitute pyrrole, thiophene, and substituted thiophene.

Aniline, pyrrole or thiophene can be substituted with one or more substitute groups. Examples of substitute groups can include, but not limited to, alkyl having 1-20 carbon atoms, aryl having 6-20 carbon atoms, ether having 1-20 carbon atoms, alkyl-sulfonate groups, aryl-sulfonate groups, alkylthiols, sulfonic acid groups, alkoxy groups, thiol groups, carboxylate groups, or other carbon or non-carbon substitute groups.

Examples of substituted pyrroles can include: 1H-pyrrole-1- propionic acid, 11-(1H-pyrrol-1-yl)undecane-1-thiol, 1-(4-Methylphenyl)-1H-pyrrole, 1-(4-Methoxyphenyl)-1H-pyrrole, and 1-(4-Nitrophenyl)-1H-pyrrole.

Examples of substituted thiophene can include hydroxymethyl ethylenedioxythiophene.

In one example, polyaniline can be polymerized aniline, substituted aniline, or a mixture of aniline and substituted aniline.

In another example, polypyrrole can polymerized pyrrole, substituted pyrrole, or a mixture of pyrrole and substituted pyrrole.

In yet another example, poly(aniline/pyrrole) copolymer can be polymerized from a mixture of aniline/substituted aniline and pyrrole/substituted pyrrole, or a mixture thereof. The poly(aniline/pyrrole) copolymer can be a block copolymer or a random copolymer. In further example, pyrrole and aniline can be added to a polymerization reaction sequentially to form a block copolymer. In yet further an example, both aniline and pyrrole can be added into a polymerization reaction to form a random copolymer.

The one or more film forming polymers can be selected from the group consisting of one or more polyester polymers, one or more acrylic polymers, epoxy polymers, melamine polymers, formaldehyde polymers, polyurethane polymers, and a combination thereof. Commercial polymers or polymer products can be suitable. Examples of commercial products can include CorMax®, CorMax® VI, Epoxy/Amine resin, ElectoShield™, aqueous-based polyester melamine resin such as WB primer DW 459, all available from E. I. du Pont de Nemours & Co., Wilmington, Del., USA, under respective trademarks or registered trademarks.

At least one of the film forming polymers can have one or more crosslinkable functional groups selected from hydroxyl, thiol, isocyanate, thioisocyanate, acid or polyacid, acetoacetoxy, carboxyl, primary amine, secondary amine, epoxy, anhydride, ketimine, aldimine, orthoester, orthocarbonate, cyclic amide, or a combination thereof. The coating composition can further comprise a crosslinking component having one or more crosslinking functional groups. The crosslinking functional groups can be selected from isocyanate, blocked isocyanate, thioisocyanate, melamine, ketimine, acid, polyacid, acetoacetoxy, carboxyl, primary amine, secondary amine, or a combination thereof. Appropriate pairs of crosslinkable and crosslinking functional groups can be determined based on the aforementioned paired combinations.

The polyester polymers suitable for this invention can be linear polyesters, branched polyesters, or a combination thereof. The polyesters can have one or more crosslinkable functional groups. The polyesters may be saturated or unsaturated and optionally, may be modified with fatty acids. These polyesters can be the esterification product of one or more polyhydric alcohols, such as, alkylene diols and glycols; and carboxylic acids such as monocarboxylic acids, polycarboxylic acids or anhydrides thereof, such as, dicarboxylic and/or tricarboxylic acids or tricarboxylic acid anhydrides.

The polyester can also be highly branched copolyesters. The highly branched copolyester can have one or more crosslinkable function groups. The highly branched copolyester can be conventionally polymerized from a monomer mixture containing a dual functional monomer selected from the group consisting of a hydroxy carboxylic acid, a lactone of a hydroxy carboxylic acid and a combination thereof; and one or more hyper branching monomers.

Conventional methods for synthesizing polyesters are known to those skilled in the art. Examples of the conventional methods can include those described in U.S. Pat. No. 5,270,362 and U.S. Pat. No. 6,998,154.

The acrylic polymer suitable for this invention can have a weight average molecular weight (Mw) in a range of from 2,000 to 100,000, and can contain crosslinkable functional groups, for example, hydroxyl, amino, amide, glycidyl, silane and carboxyl groups. These acrylic polymers can be straight chain polymers, branched polymers, graft copolymers, or other polymers. In one example, the acrylic polymer can have a weight average molecular weight in a range of from 5,000 to 50,000. In another example, the acrylic polymer can have a weight average molecular weight in a range of from 5,000 to 25,000. Typical example of useful acrylic polymers can be polymerized from a plurality of monomers, such as acrylates, methacrylates, derivatives of acrylates or methacrylates, or a combination thereof.

The acrylic polymers can generally be polymerized by free-radical copolymerization using conventional processes well known to those skilled in the art, for example, bulk, solution or bead polymerization, in particular by free-radical solution polymerization using free-radical initiators.

The acrylic polymer can contain (meth)acrylamides. Typical examples of such acrylic polymers can be polymerized from monomers including (meth)acrylamide. In one example, such acrylic polymer can be polymerized from (meth)acrylamide and alkyl (meth)acrylates, hydroxy alkyl (meth)acrylates, (meth)acrylic acid and one of the aforementioned olefinically unsaturated monomers.

Epoxy polymers can also be suitable. Any epoxy polymers suitable for coating can be used. Modified epoxy polymers can also be suitable. Examples of epoxy polymer or modified epoxy polymer can include commercial epoxy resins, such as CorMax® VI, Epoxy/Amine Resin, or ElectoShield™, all available from E. I. DuPont de Nemours & Co., Wilmington, USA, under respected trademarks or registered trademarks.

Melamine polymers can also be suitable. Any melamine polymers suitable for coating can be used.

Typically, the coating composition of this disclosure can further contain a catalyst to reduce curing time and to allow curing of the coating composition at ambient temperatures. The ambient temperatures are typically referred to as temperatures in a range of from about 18° C. to about 35° C. Typical catalysts can include dibutyl tin dilaurate, dibutyl tin diacetate, dibutyl tin dichloride, dibutyl tin dibromide, triphenyl boron, tetraisopropyl titanate, triethanolamine titanate chelate, dibutyl tin dioxide, dibutyl tin dioctoate, tin octoate, aluminum titanate, aluminum chelates, zirconium chelate, hydrocarbon phosphonium halides, such as, ethyl triphenyl phosphonium iodide and other such phosphonium salts, and other catalysts or mixtures thereof known to those skilled in the art.

The coating composition of this disclosure can comprise one or more solvents. Typically the coating composition can comprise up to about 95% by weight, based on the weight of the coating composition, of one or more solvents. Typically, the coating composition of this disclosure can have a solid content in a range of from about 20% to about 80% by weight in one example, in a range of from about 50% to about 80% by weight in another example and in a range of from about 60% to about 80% by weight in yet another example, all based on the total weight of the coating composition. The coating composition of this disclosure can also be formulated at 100% solids by using a low molecular weight acrylic resin reactive diluent.

Any typical organic solvents can be used to form the coating composition of this disclosure. Examples of solvents include, but not limited to, aromatic hydrocarbons, such as, toluene, xylene; ketones, such as, acetone, methyl ethyl ketone, methyl isobutyl ketone, methyl amyl ketone and diisobutyl ketone; esters, such as, ethyl acetate, n-butyl acetate, isobutyl acetate and a combination thereof.

The coating composition can further comprise one or more pigments, dyes, organic solvents, water, ultraviolet light stabilizers, ultraviolet light absorbers, antioxidants, hindered amine light stabilizers, leveling agents, rheological agents, thickeners, antifoaming agents, wetting agents, catalysts, or a combination thereof. Any of the aforementioned pigments can be suitable.

The coating composition can further comprise a crosslinkable component having one or more crosslinkable functional groups. This crosslinkable component can have additional polymers same or different from the aforementioned film forming polymers. The crosslinkable component can have crosslinkable functional groups the same or different from the ones in said film forming polymers. The crosslinkable functional groups can be selected from hydroxyl, thiol, epoxy, anhydride, aldimine, orthoester, orthocarbonate, cyclic amide, or a combination thereof. When such crosslinkable component is present, the coating composition can further comprise a crosslinking component have one or more crosslinking functional groups that can react with the crosslinkable groups in the crosslinkable component. The crosslinking component can comprise one or more crosslinking agents. The crosslinking agents that are suitable for the coating composition of this invention can include compounds having crosslinking functional groups. Examples of such compounds can include organic polyisocyanates, melamine, or other compound containing any of the aforementioned crosslinking functional groups. Examples of organic polyisocyanates include aliphatic polyisocyanates, cycloaliphatic polyisocyanates, aromatic polyisocyanates and isocyanate adducts.

The coating composition can further comprise one or more subsequent polymers same or different from said one or more film forming polymers. In one example, the coating composition can comprise a subsequent polyester polymer the same or different from the one or more film forming polymers that are present during polymerization of the electroconductive polymers. In another example, the subsequent polymer can be acrylic polymer, polyester, polyurethane, or a combination thereof. The subsequent polymer can have one or more functional groups the same or different from the functional groups in said one or more film forming polymers. The subsequent polymers can be film forming polymers. In one example, the electroconductive polymer polymerized according to this disclosure can be added to a different primer coating composition.

The coating composition can be electroconductive.

The coating composition can be waterborne or solvent borne. A waterborne coating composition can comprise in a range of from about 20% to about 80% of water, percentage based on the total weight of the coating composition. A waterborne coating composition can also have one or more of the aforementioned organic solvents. A solvent borne coating composition can comprise one or more of the aforementioned organic solvents and in a range of from 0% to about 20% of water, percentage based on the total weight of the coating composition.

Typically, when the coating composition of this disclosure is utilized as a pigmented coating composition, it contains pigments in a pigment to binder weight ratio of about 1/100 to about 350/100. The coating composition can be used as a basecoat or topcoat, such as a colored topcoat. Conventional inorganic and organic colored pigments, metallic flakes and powders, such as, aluminum flake and aluminum powders; special effects pigments, such as, coated mica flakes, coated aluminum flakes colored pigments, a combination thereof can be used. Transparent pigments or pigments having the same refractive index as the cured binder can also be used. Such transparent pigments can be used in a pigment to binder weight ratio of about 0.1/100 to about 5/100. One example of such transparent pigment is silica.

The coating composition of this disclosure can also comprise one or more ultraviolet light stabilizers in the amount of about 0.1% to about 10% by weight, based on the weight of the binder. Examples of such ultraviolet light stabilizers can include ultraviolet light absorbers, screeners, quenchers, and hindered amine light stabilizers. An antioxidant can also be added to the coating composition, in the amount of about about 0.1% to about 5% by weight, based on the weight of the binder.

Typical ultraviolet light stabilizers that are suitable for this disclosure can include benzophenones, triazoles, triazines, benzoates, hindered amines and mixtures thereof. A blend of hindered amine light stabilizers, such as Tinuvin® 328 and Tinuvin® 123, all commercially available from Ciba Specialty Chemicals, Tarrytown, N.Y., under respective registered trademark, can be used.

Typical ultraviolet light absorbers that are suitable for this disclosure can include hydroxyphenyl benzotriazoles, such as, 2-(2-hydroxy-5-methylphenyl)-2H-benzotrazole, 2-(2-hydroxy-3,5-di-tert.amyl-phenyl)-2H-benzotriazole, 2[2-hydroxy-3,5-di(1,1-dimethylbenzyl)phenyl]-2H-benzotriazole, reaction product of 2-(2-hydroxy-3-tert.butyl-5-methyl propionate)-2H-benzotriazole and polyethylene ether glycol having a weight average molecular weight of 300, 2-(2-hydroxy-3-tert.butyl-5-iso-octyl propionate)-2H-benzotriazole; hydroxyphenyl s-triazines, such as, 2-[4((2,-hydroxy-3-dodecyloxy/tridecyloxypropyl)-oxy)-2-hydroxyphenyl]-4,6-bis(2,4-dimethylphenyl)-1,3,5-triazine, 2-[4(2-hydroxy-3-(2-ethylhexyl)-oxy)-2-hydroxyphenyl]-4,6-bis(2,4-dimethylphenyl) 1,3,5-triazine, 2-(4-octyloxy-2-hydroxyphenyl)-4,6-bis(2,4-dimethylphenyl)-1,3,5-triazine; hydroxybenzophenone U.V. absorbers, such as, 2,4-dihydroxybenzophenone, 2-hydroxy-4-octyloxybenzophenone, and 2-hydroxy-4-dodecyloxybenzophenone.

Typical antioxidants that are suitable for this disclosure can include tetrakis[methylene(3,5-di-tert-butylhydroxy hydrocinnamate)]methane, octadecyl 3,5-di-tert-butyl-4-hydroxyhydrocinnamate, tris(2,4-di-tert-butylphenyl) phosphite, 1,3,5-tris(3,5-di-tert-butyl-4-hydroxybenzyl)-1,3,5-triazine-2,4,6(1H,3H,5H)-trione and benzenepropanoic acid, 3,5-bis(1,1-dimethyl-ethyl)-4-hydroxy-C7-C9 branched alkyl esters. Typically useful antioxidants can also include hydroperoxide decomposers, such as Sanko® HCA (9,10-dihydro-9-oxa-10-phosphenanthrene-10-oxide), triphenyl phosphate and other organo-phosphorous compounds, such as, Irgafos® TNPP from Ciba Specialty Chemicals, Irgafos® 168, from Ciba Specialty Chemicals, Ultranox® 626 from GE Specialty Chemicals, Mark PEP-6 from Asahi Denka, Mark HP-10 from Asahi Denka, Irgafos® P-EPQ from Ciba Specialty Chemicals, Ethanox 398 from Albemarle, Weston 618 from GE Specialty Chemicals, Irgafos® 12 from Ciba Specialty Chemicals, Irgafos® 38 from Ciba Specialty Chemicals, Ultranox® 641 from GE Specialty Chemicals and Doverphos® S-9228 from Dover Chemicals.

Typical hindered amine light stabilizers can include N-(1,2,2,6,6-pentamethyl-4-piperidinyl)-2-dodecyl succinimide, N(1acetyl-2,2,6,6-tetramethyl-4-piperidinyl)-2-dodecyl succinimide, N-(2hydroxyethyl)-2,6,6,6-tetramethylpiperidine-4-ol-succinic acid copolymer, 1,3,5 triazine-2,4,6-triamine, N,N′″-[1,2-ethanediybis[[[4,6-bis[butyl (1,2,2,6,6-pentamethyl-4-piperidinyl)amino]-1,3,5-triazine-2-yl]imino]-3,1-propanediyl]]bis [N, N′″-dibutyl-N′,N′″-bis(1,2,2,6,6-pentamethyl-4-piperidinyl)], poly-[[6-[1,1,3,3-tetramethylbutyl)-amino]-1,3,5-trianzine-2,4-diyl][2,2,6,6-tetramethylpiperidinyl)-imino]-1,6-hexane-diyl[(2,2,6,6-tetramethyl-4-piperidinyl)-imino]), bis(2,2,6,6-tetramethyl-4-piperidinyl)sebacate, bis(1,2,2,6,6-pentamethyl-4-piperidinyl)sebacate, bis(1-octyloxy-2,2,6,6-tetramethyl-4-piperidinyl)sebacate, bis(1,2,2,6,6-pentamethyl-4-piperidinyl)[3,5bis(1,1-dimethylethyl-4-hydroxy-phenyl)methyl]butyl propanedioate, 8-acetyl-3-dodecyl-7,7,9,9,-tetramethyl-1,3,8-triazaspiro(4,5)decane-2,4-dione, and dodecyl/tetradecyl-3-(2,2,4,4-tetramethyl-21-oxo-7-oxa-3,20-diazal dispiro(5.1.11.2)henicosan-20-yl)propionate.

The coating compositions of this disclosure can further comprise conventional coating additives. Examples of such additives can include wetting agents, leveling and flow control agents, for example, Resiflow® S (polybutylacrylate), BYK® 320 and 325 (high molecular weight polyacrylates), BYK® 347 (polyether-modified siloxane) under respective registered tradmarks, leveling agents based on (meth)acrylic homopolymers; rheological control agents, such as highly disperse silica, fumed silica or polymeric urea compounds; thickeners, such as partially crosslinked polycarboxylic acid or polyurethanes; antifoaming agents; catalysts for the crosslinking reaction of the OH-functional binders, for example, organic metal salts, such as, dibutyltin dilaurate, zinc naphthenate and compounds containing tertiary amino groups, such as, triethylamine, for the crosslinking reaction with polyisocyanates. The additives are used in conventional amounts familiar to those skilled in the art.

The coating compositions according to the disclosure can further contain reactive low molecular weight compounds as reactive diluents that are capable of reacting with the crosslinking agent. For example, low molecular weight polyhydroxyl compounds, such as, ethylene glycol, propylene glycol, trimethylolpropane and 1,6-dihydroxyhexane can be used.

Depending upon the type of crosslinking agent, the coating composition of this disclosure can be formulated as one-pack (1K) or two-pack (2K) coating composition. If polyisocyanates with free isocyanate groups are used as the crosslinking agent, the coating composition can be formulated as a two-pack coating composition in that the crosslinking agent is mixed with other components of the coating composition only shortly before coating application. If blocked polyisocyanates are, for example, used as the crosslinking agent, the coating compositions can be formulated as a one-pack (1K) coating composition. The coating composition can be further adjusted to spray viscosity with organic solvents before being applied as determined by those skilled in the art. A 1K coating composition can comprise melamine or melamine derivatives as crosslinking agent. Coatings produced with such coating composition can be cured at elevated temperatures, such as in a range of from about 80° C. to about 200° C.

In a typical two-pack coating composition comprising two packages, the two packages are mixed together shortly before application. The first package typically can contain the acrylic polymer, the polyesters, and the polytrimethylene ether diol and pigments. The pigments can be dispersed in the first package using conventional dispersing techniques, for example, ball milling, sand milling, and attritor grinding. The second package can contain the crosslinking agent, such as, a polyisocyanate crosslinking agent, and solvents.

The coating composition can be applied over a substrate using coating application techniques or processes, such as brushing, drawdown coating, spraying, roller coating, dipping, soaking, electro-coating, or coating application techniques known to or developed by those skilled in the art. The coating composition can be conductive. The coating composition can comprise conductive carrier, one or more conductive pigments, one or more salts, one or more conductive polymers, or a combination thereof. The coating composition can also be charged during coating application process.

The coating composition according to the disclosure can be suitable for vehicle and industrial coating and can be applied by conventional coating techniques. In the context of vehicle coating, the coating composition can be used both for vehicle original equipment manufacturing (OEM) coating and for repairing or refinishing coatings of vehicles and vehicle parts. Curing of the coating composition can be accomplished at ambient temperatures, such as temperatures in a range of from about 18° C. to about 35° C., or at elevated temperatures, such as at temperatures in a range of from about 35° C. to about 250° C. Typical curing temperatures of from about 20° C. to about 80° C., in particular of from about 20° C. to about 60° C., can be used for vehicle repair or refinish coatings. Typical curing temperatures in a range of from about 80° C. to about 250° C., in particular in a range of from about 80° C. to about 200° C., can be used for OEM coatings.

This disclosure is also directed to a coated article comprising a metal substrate coated with one or more coating layers thereon, wherein at least one of the coating layers is formed from the coating composition of this disclosure. The metal substrate can be a vehicle body, vehicle body part, tank, rail, building, appliance or appliance part. The metal substrate can comprise steel, aluminum, copper, iron, alloys, or a combination thereof.

The electroconductive polymer can be polymerized by a process comprising steps of reacting a reaction mixture comprising:

(a) at least one monomer selected from the group consisting of pyrrole, substituted pyrrole, aniline, substituted aniline, thiophene, substituted thiophene, and a combination thereof; and

(b) one or more polymers selected from the group consisting of acrylic polymers, polyester polymers, epoxy polymers, melamine polymers, formaldehyde polymers, polyurethane polymers, and a combination thereof to form a modified resin.

In one example, the reaction mixture can further comprise: potassium tetraoxalate and ammonium persulfate.

In another example, the reaction mixture can further comprise: dodecylbenzenesulfonic acid and ammonium persulfate.

In yet another example, the reaction mixture can further comprise an acid selected from the group consisting of: octyl-benzene sulfonic acid; camphor sulfonic acid; m-sulfamic acid; oxalic acid; poly(styrene sulfonic) acid; dinonylnaphthalene sulfonic acid; and nitrilotris(methylene)-triphosphonic acid.

The one or more polymers can be selected from the group consisting of CorMax® VI, Epoxy/Amine resin, and ElectoShield™., all available from E. I. du Pont de Nemours & Co., Wilmington, Del., USA, under respective trademark or registered trademark. In one example, the polymers can comprise a polyester polymer. In another example, the polymers can comprise acrylic polymers. In a further example, the polymers can comprise a combination of acrylic and polyester polymers, or a modified epoxy polymers.

The monomers can be selected from pyrrole, and optionally, a substituted pyrrole, or a combination thereof, in one example; aniline, and optionally, a substituted aniline, or a combination thereof, in another example.

The modified resin can be isolated from the reaction mixture. Insoluble materials in the reaction mixture can be removed by filtration.

The isolated modified resin can be dissolved in an organic solvent. In one example, the modified resin can be dissolved in methyl isobutyl ketone (MIBK) to form a resin-MIBK solution.

The resin-MIBK solution can be used directly over a substrate to form an anticorrosion coating. The resin-MIBK solution can also be to formulated into the aforementioned coating composition of this disclosure.

The electroconductive polymer can also be polymerized from the aforementioned reaction mixture in the presence of a metal substrate. In one example, the polymerization of pyrrole, thiophene, or aniline can be conducted directly on CRS in the presence of potassium tetraoxalate as dopant and oxidant. Under these conditions, an iron(II) oxalate dihydrate passive/adhesion layer may be formed on CRS, improving the adhesion of the polymer coating to the metal substrate.

The modified resins can be water-soluble or water-dispersible.

This disclosure is further directed to a process for producing an anti-corrosion coating layer over a metal substrate. The process can comprise the steps of:

i) providing the aforementioned coating composition of this disclosure;

ii) applying said coating composition over the metal substrate to form a wet coating layer; and

iii) curing said wet coating layer to form said anti-corrosion coating layer.

Any of the aforementioned coating composition can be suitable.

The coating composition can be applied over said metal substrate by electro-coating, spray coating, drawdown coating, roller coating, dipping, soaking, brushing, or a combination thereof. In one example, a metal substrate can be electro-coated with the coating composition of this disclosure. In another example, the electro-coated substrate can be further spray coated or brush coated.

The metal substrate can be a vehicle body, vehicle body part, tank, rail, building, appliance or appliance part. The metal substrate can comprise steel, aluminum, copper, iron, alloys, or a combination thereof. The alloys can comprise two or more metals. In one example, the metal substrate can be cold roll steel (CRS), or phosphate treated CRS.

### Testing Procedures

Dry Film Thickness—measured with a Fisherscope® instrument available from HELMUT FISCHER GMBH, Sindelfingen-Maichingen, Germany.

Salt Spray Corrosion Test—performed in a salt spray chamber according to ASTM G 85 Standard Practice for Modified Salt Spray (Fog) Testing.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Example 1

Pyrrole (6.709 g) was added to 200 g of a mixture of film-forming polymers (WB primer DW 459, available from E. I. du Pont de Nemours & Co., Wilmington, Del., USA) while stirring using an overhead stirrer and cooling the flask in an ice bath. Potassium tetraoxalate (25.419 g, which had previously been ground up to produce a fine solid) was then added. This mixture was cooled to about 0-2° C. before the addition of 22.818 g of ammonium persulfate. The color changed from light brown to dark black, and the temperature increased to about 40° C. The temperature quickly decreased, and the mixture was left for 24 h. Methyl isobutyl ketone (MIBK) (400 mL) was added to the flask and heated to 60-70° C. using an oil bath, while stirring constantly. A few small soft chunks of solid material would not dissolve, so the mixture was filtered and used “as is” in the following examples.

### Example 2

A portion of the MIBK solution synthesized according to the process described in Example 1 was drawn down on a cold rolled steel (CRS) substrate to form a coating film using a 5 mil applicator. The coating film was dried in air for 48 h and then was dried in an oven at 180 oC for 20 min to form a coated CRS panel. The thickness of the coating film measured with a Fisherscope® instrument was 25 microns. The coated CRS panels were subjected to a corrosion test in a salt spray chamber according to ASTM G 85 Standard Practice for Modified Salt Spray (Fog) Testing, and their appearance and corrosion resistance was monitored for 1512 h. The coated panels showed no loss of adhesion and no corrosion except the scribe line, even after 1512 h.

### Comparative Example A

A film was drawn down on CRS using an aqueous-based polyester melamine resin (WB primer DW 459), and the same applicator and conditions as described in Example 2.The coated CRS panel was subjected to the same corrosion test described in Example 2. A high degree of rusting of the CRS substrate was observed after 120 h of exposure.

### Example 3

This example illustrates the polymerization and doping of aniline in a low-temperature bake emulsion matrix, with subsequent electro-coating of the coating composition onto CRS panels.

Dodecylbenzenesulfonic acid (1.9 g) was dissolved into 40 mL water at room temperature in a stainless steel beaker using a high-speed dispersion blade at 1000 RPM for 15 min. This solution was then added to 266 g of low-temperature bake emulsion (ElectroShield™ 24, available from E. I. du Pont de Nemours & Co., Wilmington, Del., USA, under respective trademark), pH 6.38, at room temperature over 1 h, with 400-500 RPM overhead stirring. There was no exotherm, and no precipitation was observed. The pH was 6.37. The mixture was cooled to 0° C. in an ice bath, and aniline (1.1 g) was added over 14 min, with no exotherm. The pH was 7.04. After stirring for 10 min, ammonium persulfate (0.78 g) in 10 mL water (which had been previously cooled to 0° C. in an ice bath) was then added over 30 min at 0° C. with 800 RPM stirring. Some black solids could be seen, but the solution was mostly off white (beige) in color. After stirring for 40 min at 0° C., the solution was beige and still fluidal. After an additional 1 h of stirring at 0° C., the solution was beige and somewhat thicker. The solution was then warmed to room temperature, and become thicker. Additional water was added to bring original 40% solid concentration to 15%. The solution was rolled to mix for about 18 h, and then electro-coated onto CRS panels.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A coating composition comprising at least one electroconductive polymer polymerized in the presence of one or more film forming polymers selected from the group consisting of polyester polymers, acrylic polymers, epoxy polymers, melamine polymers, formaldehyde polymers, polyurethane polymers, and a combination thereof.

2. The coating composition of claim 1, wherein said electroconductive polymer is selected from polyaniline, polypyrrole, polythiophene, or a combination thereof.

3. The coating composition of claim 2, wherein said electroconductive polymer is polypyrrole polymerized from pyrrole, substituted pyrrole, or a combination thereof, in the presence of said one or more film forming polymers.

4. The coating composition of claim 2, wherein said electroconconductive polymer is polyaniline polymerized from aniline, substituted aniline, or a combination thereof, in the presence of said one or more film forming polymers.

5. The coating composition of claim 1, wherein said electroconconductive polymer is a poly(aniline/pyrrole) polymerized from a reaction mixture comprising a first monomer mix comprising aniline, substituted aniline, or a combination thereof, a second monomer mix comprising pyrrole, substituted pyrrole, or a combination thereof, and said one or more film forming polymers.

6. The coating composition of claim 1, wherein at least one of the film forming polymers having one or more crosslinkable functional groups selected from hydroxyl, thiol, isocyanate, thioisocyanate, acid or polyacid, acetoacetoxy, carboxyl, primary amine, secondary amine, epoxy, anhydride, ketimine, aldimine, orthoester, orthocarbonate, cyclic amide, or a combination thereof.

7. The coating composition of claim 6 further comprising a crosslinking component having one or more crosslinking functional groups.

8. The coating composition of claim 7, wherein said crosslinking functional groups are selected from isocyanate, blocked isocyanate, thioisocyanate, melamine, ketimine, acid, polyacid, acetoacetoxy, carboxyl, primary amine, secondary amine, or a combination thereof.

9. The coating composition of claim 1 further comprising one or more pigments, dyes, organic solvents, water, ultraviolet light stabilizers, ultraviolet light absorbers, antioxidants, hindered amine light stabilizers, leveling agents, rheological agents, thickeners, antifoaming agents, wetting agents, catalysts, or a combination thereof.

10. The coating composition of claim 1 further comprising a crosslinkable component having one or more crosslinkable functional groups.

11. The coating composition of claim 10, wherein said crosslinkable functional groups are selected from hydroxyl, thiol, epoxy, anhydride, aldimine, orthoester, orthocarbonate, cyclic amide, or a combination thereof.

12. The coating composition of claim 1 further comprising one or more subsequent polymers same or different from said one or more film forming polymers.

13. The coating composition of claim 1, wherein said coating composition is electroconductive.

14. The coating composition of claim 1 comprising in a range of from 20% to 80% water, percentage based on the total weight of the coating composition.

15. A process for producing an anti-corrosion coating layer over a metal substrate, said process comprising the steps of:
i) providing a coating composition comprising at least one electroconductive polymer polymerized in the presence of one or more film forming polymers selected from the group consisting of one or more polyester polymers, one or more acrylic polymers, epoxy polymers, melamine polymers, formaldehyde polymers, polyurethane polymers, and a combination thereof;
ii) applying said coating composition over said metal substrate to form a wet coating layer; and
iii) curing said wet coating layer to form said anti-corrosion coating layer.

16. The process of claim 15, wherein said coating composition is applied over said metal substrate by electro-coating, spray coating, drawdown coating, roller coating, dipping, soaking, brushing, or a combination thereof.

17. The process of claim 15, wherein said metal substrate is a vehicle body, vehicle body part, tank, rail, building, appliance or appliance part.

18. The process of claim 15, wherein said metal substrate comprises steel, aluminum, copper, iron, alloys, or a combination thereof.

19. A coated article comprising a metal substrate coated with one or more coating layers thereon, wherein at least one of the coating layers is formed from a coating composition comprising at least one electroconductive polymer polymerized in the presence of one or more film forming polymers selected from the group consisting of polyester polymers, acrylic polymers, epoxy polymers, melamine polymers, formaldehyde polymers, polyurethane polymers, and a combination thereof.

20. The coated article of claim 19, wherein said metal substrate is a vehicle body, vehicle body part, tank, rail, building, appliance or appliance part.

21. The coated article of claim 19, wherein said metal substrate comprises steel, aluminum, copper, iron, alloys, or a combination thereof.
